(19) United States
(12) Patent Application Publication
(10) Pub. No.: US 2005/0098257 A1
(43) Pub. Date: May 12, 2005

(54) Method and system for producing an interior trim component

(76) Inventors: John C. Bauer, Shelby Township, MI (US); Xiaohang Song, Novi, MI (US); Li Zhao, West Bloomfield, MI (US)

Correspondence Address: KEY SAFETY SYSTEMS, INC.;PATENT DEPARTMENT, 7000 NINETEEN MILE ROAD, STERLING HEIGHTS, MI, 48314, US

(21) Appl. No.: 11/016,527

(22) Filed: Dec. 17, 2004

Related U.S. Application Data
(63) Continuation of application No. 10/370,014, filed on Feb. 20, 2003.
(60) Provisional application No. 60/394,357, filed on Jul. 8, 2002.

(51) Int. Cl. B32B 35/00

(52) U.S. Cl. 156/212; 156/285

(57) ABSTRACT

A system and method for producing interior trim components is described. The system includes producing a substrate material from either metal or reinforced polymer materials. The substrate is then coated with adhesive. The adhesive coated substrate is then covered with a thick film containing artwork or a piece of natural wood veneer, which is applied using a mechanism that utilizes membrane to apply hydrostatic pressure to the thick film or the piece of natural wood veneer over the substrate in the presence of heat.

### CROSS-REFERENCE TO RELATED APPLICATIONS

This application is a continuation of U.S. patent application Ser. No. 10/370,014 filed on Feb. 20, 2003. This application claims the benefit of U.S. Provisional Application 60/394,357, filed on Jul. 8, 2002. The disclosure of the above applications is incorporated herein by reference.

### FIELD OF THE INVENTION

The present invention relates to methods for producing an interior component and, more particularly, to a method of applying graphics or wood veneer to a vehicle interior trim component.

### BACKGROUND OF THE INVENTION

With ever increasing pressure from automotive consumers, flexibility and adaptability of vehicle interiors is increasingly required in order to provide a vehicle adapted to meet the broad customer demand. Further, with increased aesthetic awareness of a vehicle's interior, there is an increasing demand to match components of the interior of a vehicle while still meeting the ever more demanding quality and cost requirements of the vehicle manufacturers. These quality requirements include, but are not limited to, exposure to elevated temperatures, water, solvents, ultra-violet exposure and exposure to gases such as xenon. Additionally, the quality requirements require the interior trim components be subjected to various physical interrogations. The increased aesthetic awareness and quality requirements have led to several technologies for incorporating graphics onto interior components.

One such technology is hydrographics, which utilizes a system wherein graphical representations are incorporated onto a rice paper type of substrate. The graphical representations are put into a moving water bath, which separates the graphical representation from a substrate. The component to which the artwork is applied is positioned within the moving water bath and mated with the graphics. After removing the component from the water bath, the part is allowed to dry and subsequently a protective layer such as a clearcoat is applied to allow the interior trim component to meet manufacturers' specifications. This technology is very cumbersome and often very expensive.

A second method for applying graphics to an interior trim component utilizes in-molded film technologies to apply graphic representation to an interior trim component. Prior to the molding of the interior trim component, a relatively thick film material having the graphical representation is positioned within the mold. In a secondary operation, plastic is injected within the mold forming the interior trim components. Slight modifications in the design of the graphics bearing film can lead to significant amounts of tooling changes. These tooling changes are very expensive and take a significant amount of time, thus complicating development time for the interior trim components.

One particular problem relates to the use of real wood components within a vehicle's interior. To date, wood interior trim components such as steering wheels, shift knobs and interior trim panels require relatively thick wood components to be handcrafted using multiple adhesive and wood layers to a specific component shape. The natural properties of the wood material, which make products made of natural wood more desirable as interior trim components, also lead to large amounts of scrap. For example, a piece of wood may be extensively worked to form a part, only to show a visible defect upon the last finishing steps. These defects, inherent in any natural product, significantly add to the time and cost of producing vehicle interior trim components.

As such, an improved system that overcomes the problems associated with known systems for coupling material having both natural and man-made graphic images to an interior trim component is necessary. It is an object of the present invention to provide a system of manufacturing an interior trim component that overcomes the deficiencies of the prior art.

### SUMMARY OF THE INVENTION

A system and method for producing interior trim components is described. The system includes producing a substrate material from either metal or reinforced polymer materials. The substrate is then coated with adhesive. The adhesive-coated substrate is then covered with a film containing artwork. The film is applied using a mechanism that utilizes a membrane (a membrane press) to apply hydrostatic pressure to the film in the presence of heat.

In one embodiment of the invention, an interior trim component is disclosed, which is formed of a substrate material. Disposed over the substrate material is a relatively thick polymer film overlay having a graphical representation disposed therein. Disposed between the substrate material and the thick polymer film is an adhesive layer, which binds the thick polymer film to the substrate material.

In another embodiment of the invention, a method for producing an interior trim component is disclosed. The interior trim component is formed by utilizing a hydrostatic pressure device to apply a thick polymer film layer having a graphical representation disposed therein over a trim component substrate. Disposed between the substrate material and the thick polymer film is an adhesive layer, which binds the thick polymer film to the substrate material.

In another embodiment of the invention, an interior trim component is disclosed, which is formed of a substrate material. Disposed over the substrate material is a natural wood veneer overlay. Disposed between the substrate material and the natural wood veneer is a woven backing applied to the wood veneer and an adhesive layer, which functions to bind the natural wood veneer to the substrate material.

In another embodiment of the invention, a method for producing an interior trim component is disclosed. The interior trim component is formed by utilizing a hydrostatic pressure device to apply a natural wood veneer over a trim component substrate. Before application, the natural wood veneer is treated with a softening solution. Disposed between the substrate material and natural wood veneer overlay is an adhesive layer, which binds the natural wood veneer overlay to the substrate material. The adhesive is at least partially cured by the hydrostatic device.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIGS. 1a-1c represent interior trim components produced according to the teachings of the present invention;

FIG. 2 represents a system for applying thin films to an interior trim component according to the teachings of the present invention;

FIG. 3 is a cross-sectional representation of the thick film used according to the teachings of the present invention;

FIG. 4 represents a shift knob utilizing a wood veneer insert according to a second teaching of the invention;

FIGS. 5a through 5d represent top and bottom perspective views of a substrate as well as cross-sectional views used in the shift knob of FIG. 4;

FIGS. 5e-5h show an alternate embodiment of a substrate.

FIG. 6 represents a top view of the natural wood veneer used to coat the substrate of FIGS. 5a and 5b;

FIGS. 7a-7c illustrate views of a tool used during the assembly of a natural wood veneer strip to the substrate;

FIG. 7d shows an alternate tool for use with an alternate substrate;

FIGS. 8a-8c represent a trim piece or insert for use in the shift knob shown in FIG. 4.

FIG. 8d is an alternate view of a wood veneer covered plastic substrate.

### DETAILED DESCRIPTION OF THE PREFERRED EMBODIMENTS

The following description of the preferred embodiments is merely exemplary in nature and is in no way intended to limit the invention, its application, or uses.

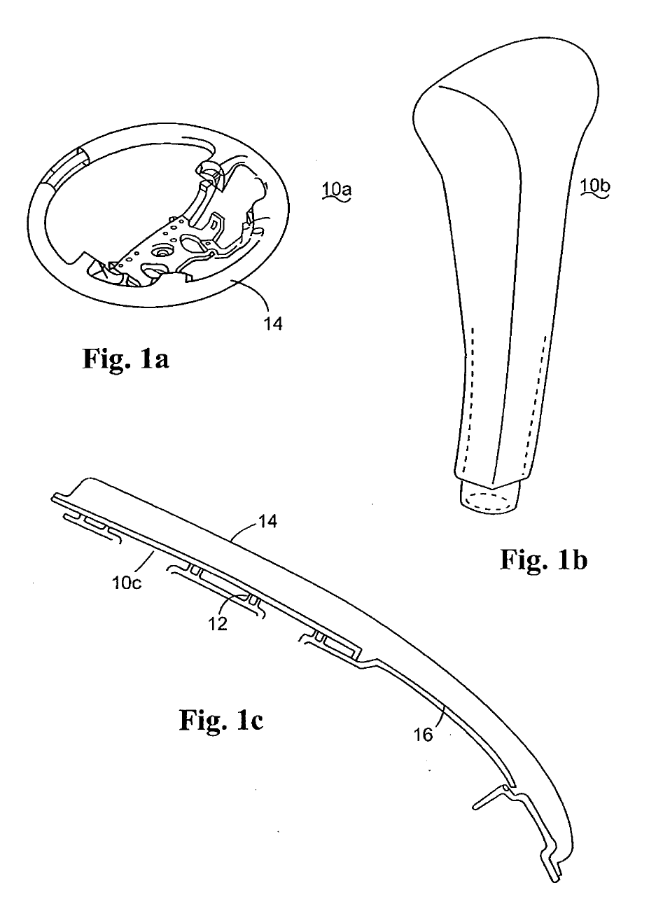

FIGS. 1a-1c represent interior trim components 10a-c produced according to the teachings of the present invention. The interior trim components 10a-c are formed by a substrate material 12. Disposed over the substrate material 12 is a relatively thick polymer film overlay 14 having a graphical representation disposed therein. Disposed between the substrate material 12 and the thick film 14 is an adhesive layer 16. FIG. 1a shows a steering wheel, FIG. 1b represents a shift knob and FIG. 1c illustrates a trim part with a relatively flat profile.

The substrate material 12 can be polymer or metallic based. It is preferred that the substrate material 12 be of a reinforced thermoplastic material such as glass reinforced nylon or polyethylene, ABS, thermoplastic olefin, or TPE. As will be described in more detail, the substrate material 12 is formed prior to its mating with the thick film 14. The adhesive layer 16 can be added either to the thick film 14 or to the substrate material 12 before the mating of the thick film 14.

In general the adhesive layer 16 is chosen to be compatible with the decorative layer (such as thick film or wood veneer) and the substrate. It is preferred the adhesive layer 16 be a water disbursed, sprayable contact adhesive having polychloroprene, glycerol ester of hydrogenated resin, resin polymer with phenol, xlene, ethyl alcohol, and zinc oxide. An example of such an adhesive is FASTBOND™ 30-NF Contact Adhesive produced by 3M. This adhesive layer 16, which can be applied to either backing sheet layer 48 of the thick film 14 or to the substrate 12, can be with or without a primer layer.

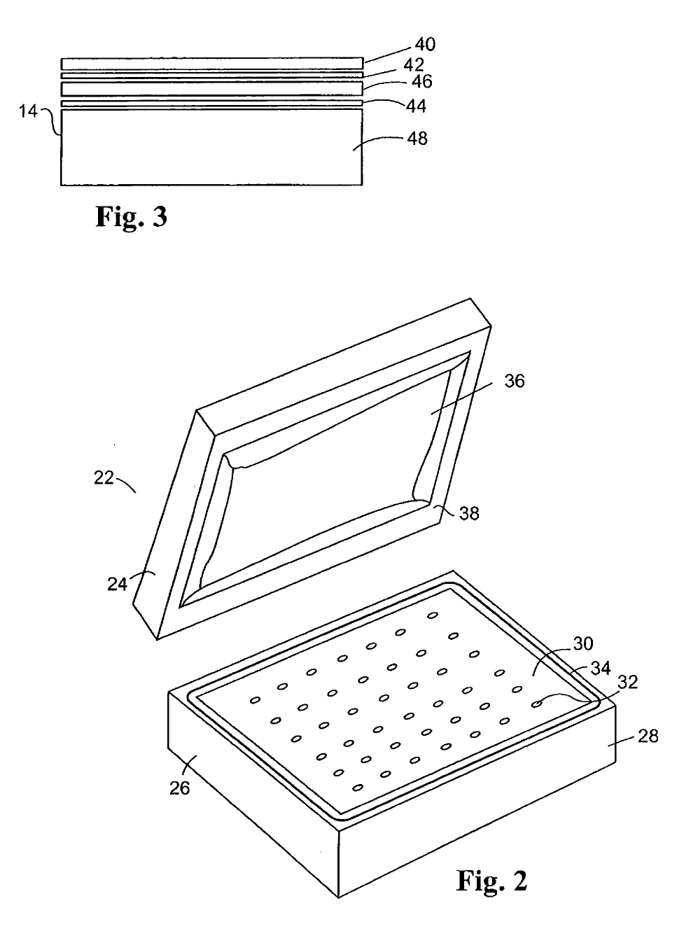

FIG. 2 represents a system for applying polymer films and other thin materials 14 to an interior trim component 10 according to the teachings of the present invention. Shown is a machine 22, which is used to apply the film 14 to the interior trim components 20. The machine 22 is divided into upper and lower halves 24 and 26. The lower half 26 has a base plate 28, which is configured to position interior trim holding fixtures 30 in a proper orientation to allow for the coupling of the film 14 to the interior trim component 20. The base plate 28 defines a plurality of orifices 32, which are used to draw air out from between the film 14 and the substrate 12. Additionally, the lower half 26 defines a sealing edge 34, which sealably mates with the upper half 24.

The upper half 24 of the machine 22 defines an elastomeric membrane 36, which is used to apply hydrostatic pressure to the outside surface of the film 14. Additionally, the upper half 24 of the machine 22 defines a sealing edge 38, which sealably mates to the sealing edge 34 of the lower half 26.

FIG. 3 is a cross-sectional representation of the thick film 14 used according to the teachings of the present invention. The thick film 14 is a laminate having a print protective clear-coat layer 40, a design layer 42, a thermoplastic tie-coat layer 44, and the backing sheet layer 48. Additionally, the thick film 14 can have a color coat layer 46 disposed between the print design layer 42 and the thermoplastic tie-coat layer 44.

The protective clearcoat layer 40 allows the thick film to meet OEM specifications. The print designed layer 42 allows any type of design to be incorporated onto the interior trim component. The color coat layer 46 allows for variations of colors within the design print. These include natural wood or tortoise shell designs as well as geometric and other designs. The thermoplastic tie coat layer 44 couples the design to the backing sheet layer 48. The backing sheet material can have a thickness from about 0.25 to 2.3 mm, and preferably between 0.25 and 0.5 mm, and most preferably 0.28 mm. The backing sheet can be formed of ABS, TPO, or polycarbonate. An example of these films is the Thermark® line of films produced by Avery Dennison.

The interior trim component 10 is formed by first producing the substrate 12. The substrate 12 is preferably formed of glass fiber reinforced nylon 6/6. The substrate 12 is then placed on a (holding) fixture and coupled to the base plate 28 of the forming machine 22. The thick film 14 containing the image to be mated to the substrate 12 is provided and can be either precut using dies, or can be a single roll width of material should several substrates be covered at one time. Adhesive 16 is sprayed or applied onto either the substrate 12 or the thick film 14. The film 14 is now placed over the substrate material 12. The top portion of the machine 22 is brought down to couple to the lower half of the machine. A vacuum is drawn through the lower baseplate to pull the thick film 14 onto the substrate 12. Pressure is applied to the elastic membrane to apply hydrostatic pressure onto the component 20. The pressure is greater than 60 psi, and preferable greater than 90 psi. The machine also includes a heat source, which raises the temperature of the film and substrate. The heat source may include a heated fluid, which is in contact with the membrane or an electric heater incorporated within the machine. Preferably, the temperature is held above 150° C. with the pressure being applied for 1 to 2 minutes. As can be appreciated the temperature and pressure profile will vary with the materials used.

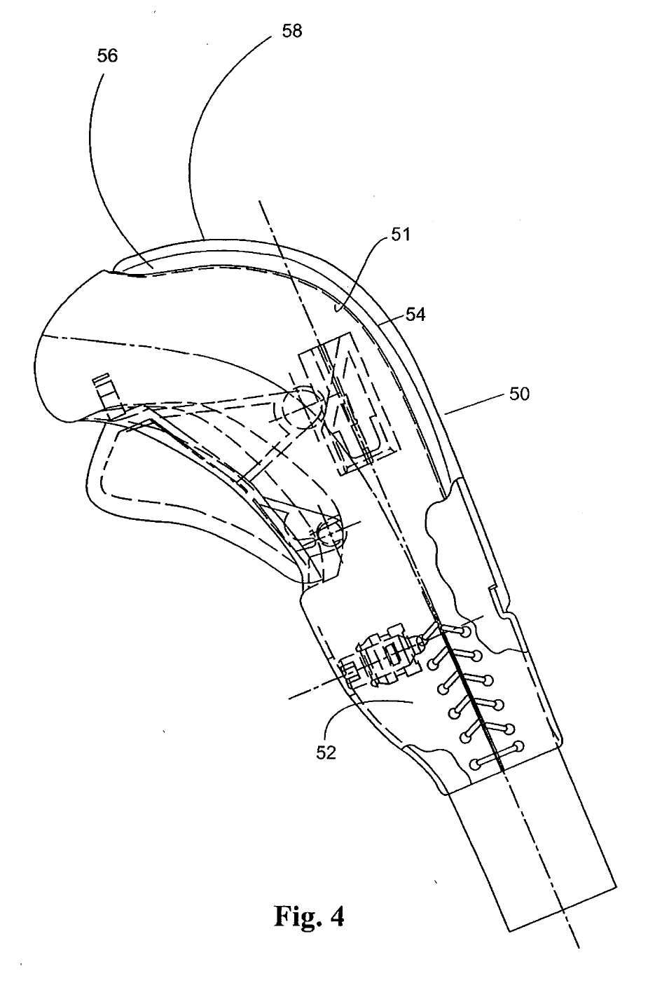

FIG. 4 represents a shift knob 50 utilizing a natural wood insert 54. The shift knob 50 has a leather wrapped body 52 positioned adjacent respective sides of the insert 54 formed of a natural wood layer 58 (and more particularly formed of a thin natural wood veneer), a synthetic substrate 56 and a protective coating. The relative thickness of the wood layer and substrate is exaggerated for the purpose of illustration.

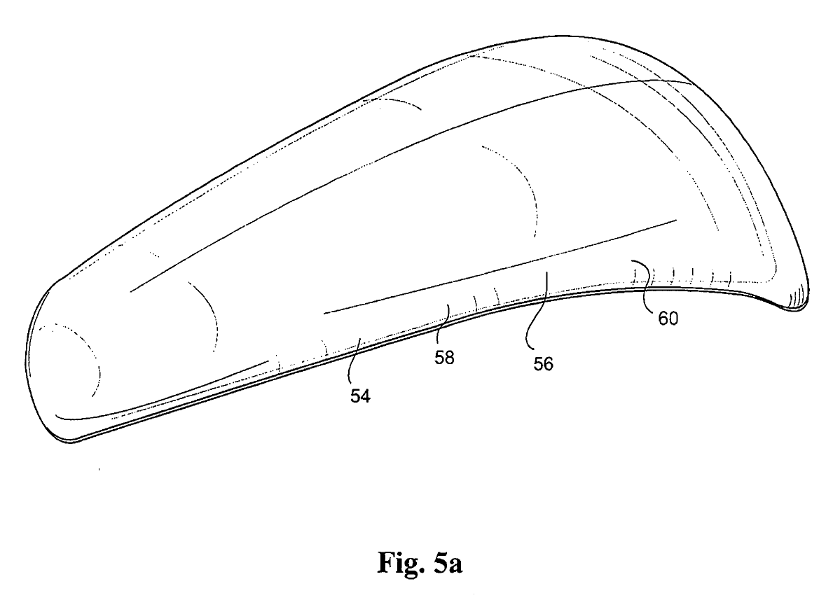

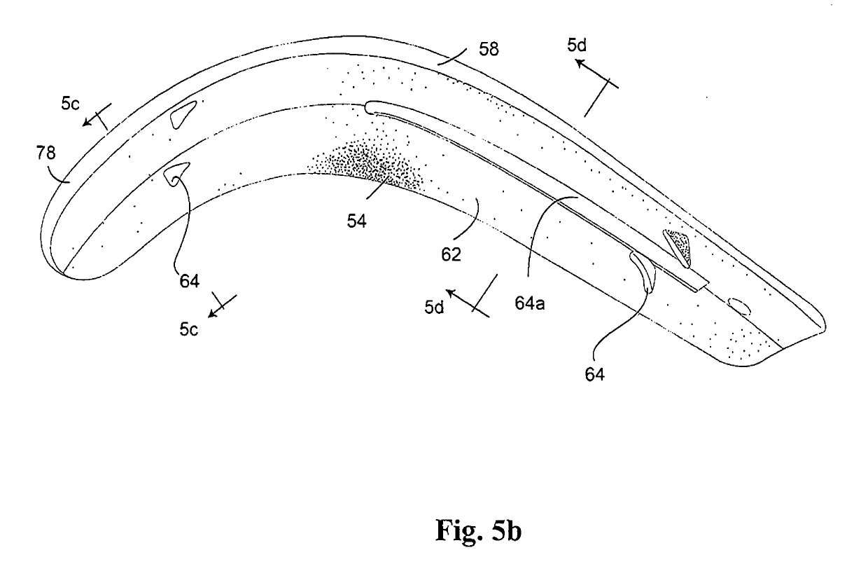

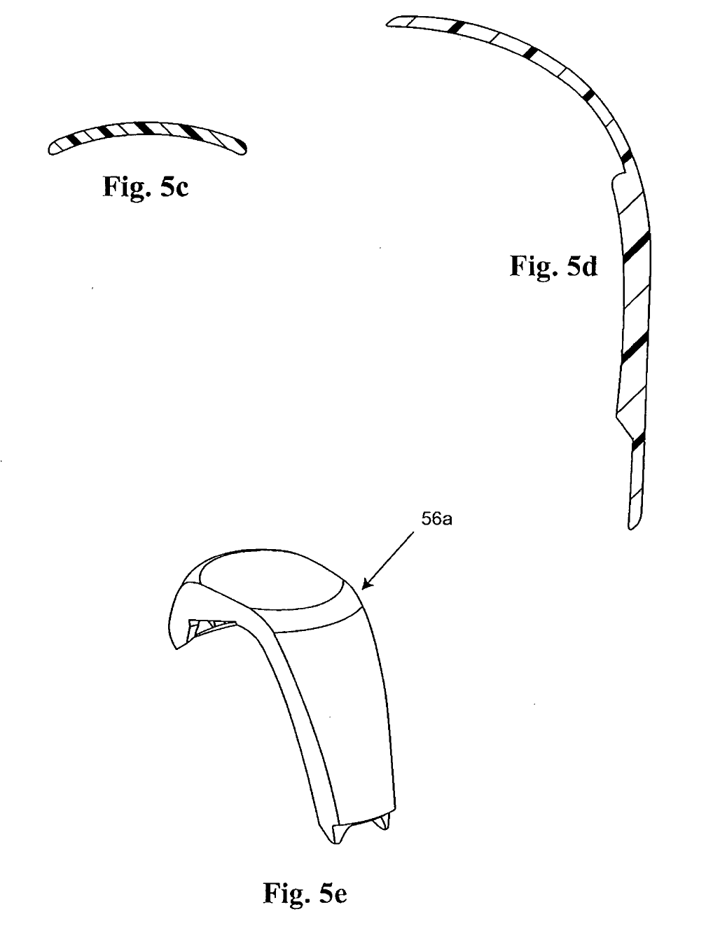

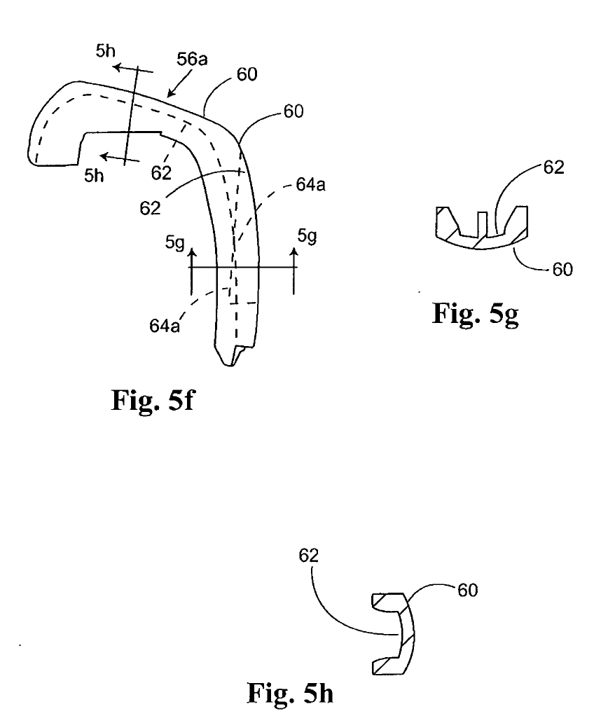

FIGS. 5a and 5b represent top and bottom perspective views of one polymer substrate 56 used in the shift knob of FIG. 4. FIGS. 5c and 5d illustrate two cross-sectional views taken through the substrate 56. FIGS. 5e-5h show another substrate 56a with a shape different from that of substrate 56. It is preferred the substrate 56 (as well as 56a) be of a reinforced thermoplastic material such as glass reinforced nylon or polyethylene, ABS, thermoplastic olefin, or TPE. The substrate 56 is formed prior to its mating with the natural wood veneer 58 or thick film as the case may be. The substrate 56 has an upper surface 60 configured to be mated to the natural wood veneer 58. The substrate 56 further has a lower surface 62 with coupling portions such as tabs 64 and 64a depending therefrom. For example tab 64 can be triangularly shaped and tab 64 can be rectangularly shaped. The tabs are configured to mate with cooperating portions of the shift knob 50 as well as cooperating portions of a holding fixture. The use of these tabs is optional and will vary with each design of the insert, holding fixture and shift knob.

As illustrated in FIGS. 4, 5a-5d the substrate is relatively thin and the top surface is arcuately shaped with a relatively smooth first curvature extending from its top to its bottom. The substrate 56a in FIGS. 5e-5h is functionally the same as the substrate 56 of the FIGS. 5a-5d but is designed to have smaller (sharper) radii of curvature along its periphery in particular at the front and rear of the substrate. The substrate 56 by comparison has a rather gradual curvature. The top surface 60 of either substrate is also curved from side-to-side to fit within the contours of a generally cylindrically shaped shift knob. Similarly the lower surface 62 generally follows the contour of the top surface 60 and as illustrated is curved from the top (of the bottom surface) to the bottom (of the bottom surface) and also curves from side-to-side.

FIG. 5e is an isometric view of substrate 56a, FIG. 5f is a side view of substrate 56a, FIG. 5g is a cross-sectional view through section lines 5g-5g of FIG. 5f, and FIG. 5h is a cross-sectional view through section lines 5h-5h of FIG. 5f.

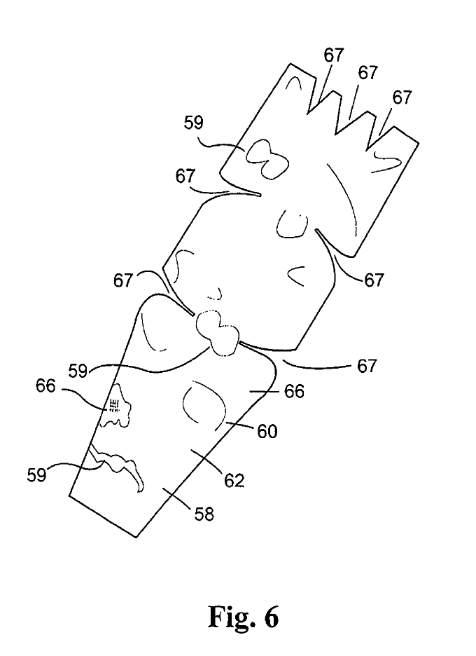

FIG. 6 represents a top plan view of a piece of the natural wood (wood veneer) 58 used to coat the substrate of FIGS. 5a and 5b. The natural wood veneer 58 can be formed of any natural wood having a thickness of between 0.2 mm and 1.2 mm, and preferably having a thickness between 0.5 and 0.6 mm. The wood (wood veneer) 58 should have a moisture content by weight of between 5% and 25% and more particularly have a moisture content of between 8% and 25%. While components have been produced with moisture contents greater than 25%, it has been found laminated components formed of wood having a moisture content of greater than 25% exhibit substrate-to-veneer delamination. Optionally, the natural wood (wood veneer) 58 can be softened using commercial softening solutions such as GF 20 produced by EP Industries, Inc. Numerals 61 show exemplary wood grain features.

Optionally, after the natural wood veneer 58 has had its moisture content modified by soaking in water or softener, a fabric backing 66 can be placed upon the rear surface of the natural wood (wood veneer) to prevent cracking of the natural wood veneer layer 58 during processing. This fabric backing 66 is preferably a 43×23 denier polyester twill cloth fabric having an incorporated vinyl-acrylic adhesive to facilitate the joining of the fabric to the natural wood veneer. The wood veneer 58 (having the thickness described above) is essentially a thin flat layer (plate) of natural wood, which will be bent during fabrication to conform with the curved upper surface 60 of the substrate 56.

To encourage the bending and placement of the wood veneer 58 about the substrate, to prevent cracking of the veneer, and to prevent the veneer from puckering as it bends about the more sharply curved portions 59 of the substrate such as substrate 56a, certain portions of the veneer 58 can optionally be removed, such as being cut or stamped away. This removed material is shown generally by numeral 67. The removed material will vary in shape and location about the wood veneer 58. By way of illustration, the contour of the veneer surrounding the removed section may be straight or curved or a combination thereof.

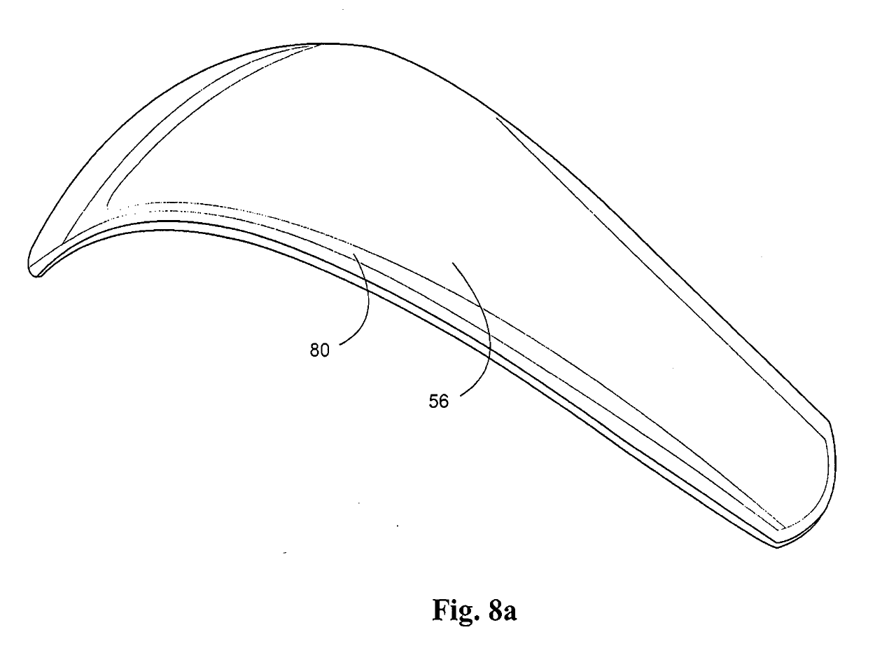

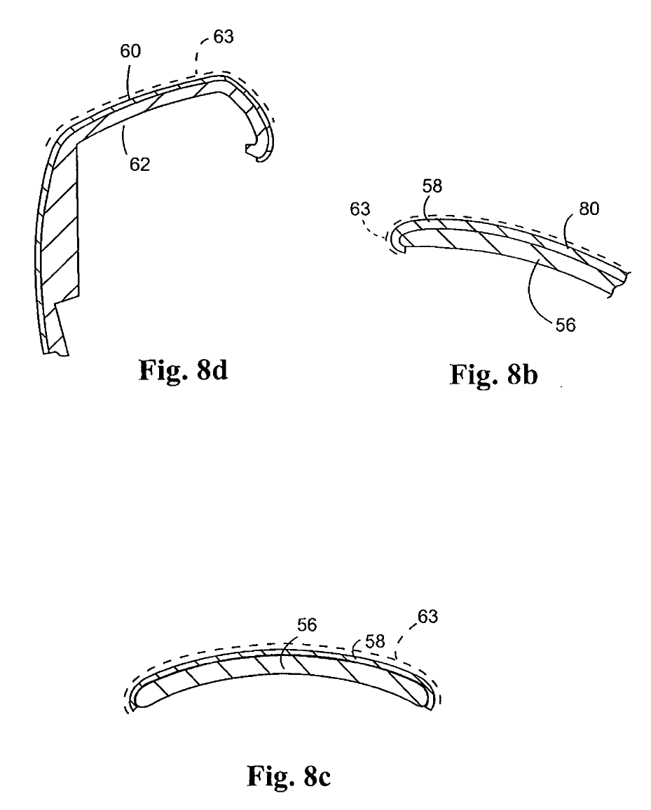

As can be appreciated, when the veneer is bent and placed upon the substrate, the portions of the veneer surrounding the removed portions move closer to each other effectively closing the spacing therebetween, see phantom lines 69 in FIG. 8. As mentioned above, the use of cutouts 67 is optional, will depend on the flexibility of the particular grade or species of wood veneer and would not typically be used with substrates having a relatively large radii of curvature.

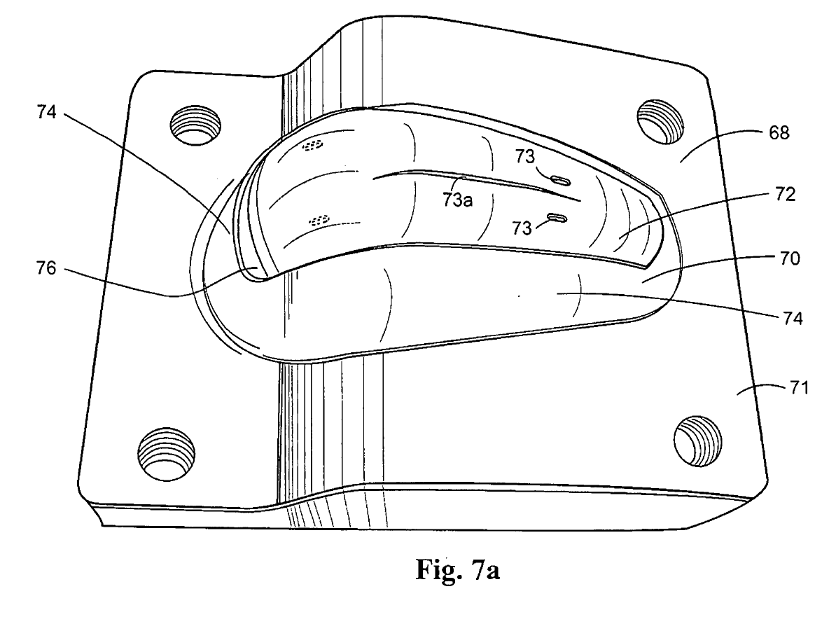

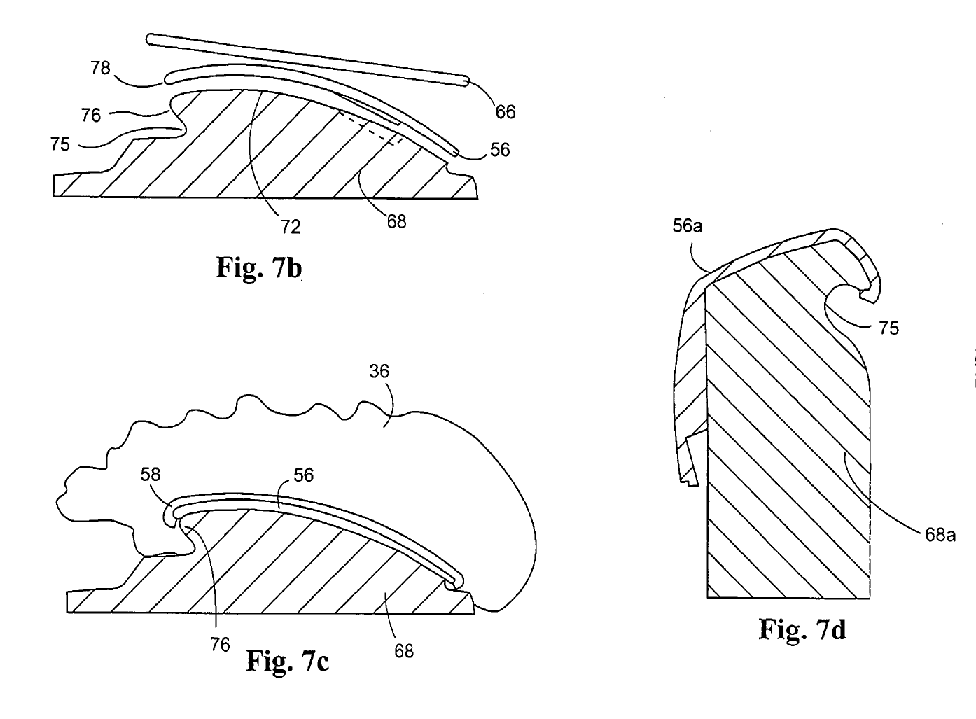

FIG. 7a represents the tool or fixture 68 used to apply the natural wood veneer 58 to the substrate 56. The fixture 68 generally defines a shoe portion 70 elevated from a base 71. The shoe portion 70 has a first upper surface 72 configured to accept the substrate material 56. This upper surface is shaped to match the contour of the lower surface 62 of the substrate 56 and includes recesses 73 and 73a to receive a respective one of the depending portions 64 and 64a to insure proper alignment of the substrate 56 to the fixture 68. Additionally, depending sidewalls 74 form the sides of the shoe portion 70.

The depending sidewalls 74 include a forward transition surface 76, which in general is inset from a peripheral edge 78 of the substrate 56 (when the substrate 56 is positioned onto the upper surface 72). The upper surface 72 can also be recessed below the top edge of the side wall in which case the lip formed by the top of the side wall functions as a retaining feature, replacing the function provided by the depending substrate tabs such as 64 and 64a, which if desired can be eliminated.

Reference is briefly made to FIG. 7b, which shows a cross-sectional view of the fixture 68 with the substrate 56 elevated above surface 72 for the purpose of illustration. Additionally, the piece of wood veneer 58 is positioned above the substrate 56. In the preferred embodiment of the invention the piece of wood veneer 58 is longer than the substrate and extends beyond a front edge 78 of the substrate 56.

As further described below the membrane 36 applies pressure upon the wood veneer 58 and eventually envelops the forward tip of the substrate as the membrane enters into and fills the space 75 provided by the undercut in the surface 76 as shown in FIG. 7c. The membrane 36 also gently urges the veneer 58 to conform to the shape of the substrate and in particular about the curved forward edge of the substrate. FIG. 7b illustrates a cross-sectional view of a holding fixture 68a to be used with substrate 56a. This fixture 68a also includes a recess 75 into which the membrane 36 can enter and bend the strip of wood veneer (not shown) so the veneer covers the forward edge of the substrate. FIG. 7c shows the wood veneer bent about the forward tip of the substrate by the membrane 36. For the purpose of illustration, the fixture 70 can be configured to also cooperate with the wood veneer and bend the veneer about the rear edge of the substrate.

FIG. 8a represents a complete interior trim part or insert 54 for use in the shift knob component 50 shown in FIG. 4. After the wood veneer 58 has been attached to the substrate 56 as described above, the insert 54 can now be finished. Recalling the insert uses a nature wood product it may be necessary to hand finish each insert to process certain surface irregularities. For example, the layer of wood veneer 58 applied to the substrate can be sanded and if necessary filled with a wood filler to correct imperfections in the natural wood veneer surface, and even a touch-up paint applied to the wood veneer to enhance the visual look of the wood's natural grain pattern. After the surface is prepared, the insert 54 can be coated with sealant 80 (shown in an exaggerated manner for the purpose of illustration and inserted into the shift knob 50 (see FIG. 4). FIG. 8d shows the wood veneer applied to the alternate substrate 56a.

FIG. 8b shows in greater detail how the front tip of the wood veneer 58 is positioned about the front edge of the substrate. In some situations it might be desirable to permit the wood veneer to also extend over and roll about the side peripheral edge of the substrate. This can be achieved by using an over-sized piece of wood veneer 58, which will be forced over the side edge of the substrate by the flexible diaphragm press. As needed the holding fixture can also include a recess along the sides of the substrate to permit the membrane press to curl the wood veneer about the side peripheral edge. The resulting construction is shown in FIG. 8c, which is a cross-sectional view across the width of the trim part or insert 54. The benefit of this overlying construction is an increased amount of the wood veneer extends below the top edge of the substrate and covers the sides of the substrate in the general vicinity of the top (of the substrate). This construction actually but more importantly visually fills any spaces 51, which may exist between the substrate and the leather wrap 52, providing a more visually pleasing part since only the wood veneer is visible and not an unfinished side of the substrate 56, which will in general have a coloration different from that of the natural wood veneer.

The process for producing the trim part or insert 54 shown in FIG. 4 is as follows. The plastic substrate 56 is formed by standard injection molding procedures. Prior to the application of the natural wood veneer 58, the plastic substrate 56 is dimensionally checked and inspected. The raw material (wood) for the veneer is pretreated. This pretreatment includes bleaching (if necessary) and softening or increasing the water content of the veneer. The veneer 58 and fabric backing 66 are cut into oversized patterns, which will allow incorporation into the cutting dies. The veneer 58 and fabric 66 are overlaid and coupled or joined utilizing an adhesive and heat treat process. The veneer 58 and cloth sub-structure 66 are cut using a stamping die to form a sub-structure, which has a peripheral dimension, which allows incorporation onto the substrate material 56. Depending upon the wood species and the curvature of the substrate 56 one or more cutouts 67 are removed from the veneer-cloth combination.

Before mating, the components are prepared for processing. In this regard, the natural wood veneer 58 may need to be additionally softened and flattened. The top surface 60 of the substrate 56 is optionally roughened. The plastic substrate 56 is then placed upon the first surface 72 of the fixture 68 and coated with a thin layer adhesive such as polyurethane glue or two-part epoxy adhesive. The precut wood veneer 58, with the cloth backing 66 applied, is aligned with the substrate and then loosely placed upon the adhesive coated surface of the substrate. In this step, the entire underside of the veneer 58 need not be pressed upon the adhesive coated surface but for example only secured at a central region.

The fixture 68 (or 68a) is then placed in a membrane press machine, which applies hydrostatic pressure to the component. A layer of protective material such as thin film is then placed between part or parts to be processed and the membrane press. Pressure (1 to 4 bars, and maximum of 6 bars) is applied through the membrane of the membrane press for 5 to 30 minutes. During the application of pressure, the trim part 54 is heated to between about 120° F. to about 300° F., which assists in the curing of the glue including the two-part epoxy adhesive. In general, the adhesive should be about 80% cured to facilitate the coupling of the wood veneer 58 to the substrate 56. The component is then removed from the fixture, permitted to cool and later trimmed within about 4 hours. The above process can be extended to a batch process in which a plurality of fixtures each with a separate piece of wood veneer 58 are placed within a membrane press and processed simultaneously.

After being trimmed, the wood veneer 58 is then filled with wood filler as needed. The wood veneer 58 is then sanded in preparation for final sealing. The veneer 58 is then coated with a layer of stain (if needed) and sealed (see phantom line 62 in FIGS. 8b-8d. The sealed coat is sanded and buffed to meet gloss and finish requirements prior to incorporation into the assembled components.

The description of the invention is merely exemplary in nature and, thus, variations that do not depart from the gist of the invention are intended to be within the scope of the invention. For example, while the formation of a shift knob is described, the methods disclosed herein can be applied to other interior trim components such as interior panels or steering wheels. Such variations are not to be regarded as a departure from the spirit and scope of the invention.

1. A method for producing interior trim comprising:
providing an interior trim substrate;
coating the substrate with an adhesive layer;
covering the substrate with a wood veneer having a thickness from about 0.2 to 1.2 mm; and
applying hydrostatic pressure to the film in the presence of heat.

2. The method according to claim 1 wherein covering the substrate with a film is covering the substrate with a wood veneer having a moisture content from about 10 and 15% water.

3. The method according to claim 1 wherein coating the substrate with an adhesive layer is coating the substrate with one of polyurethane or two component epoxy.

4. The method according to claim 1 further comprising softening the wood veneer.

5. The method according to claim 1 further comprising applying a fabric backing to the wood veneer.

6. The method according to claim 4 further comprising heating the wood veneer to couple the fabric backing.

7. The method according to claim 1 wherein covering the substrate with a wood veneer is covering the substrate with a wood veneer having a moisture content of between 8 and 25% water.

8. The method according to claim 1 wherein the substrate is a polymer material selected from the group consisting of reinforced thermoplastic material, fiber glass reinforced nylon, fiber glass polyethylene, ABS, thermoplastic olefin, and TPE.

9. The method according to claim 8 wherein the substrate has an upper surface configured to be mated to the natural wood veneer.

10. The method according to claim 8 wherein the substrate further has a lower surface having coupling portions, which are configured to mate the insert to the completed trim component.

11. A method for producing interior trim comprising:
providing an interior trim substrate;
coating the substrate with an adhesive layer;
applying a fabric backing to a wood veneer having a moisture content of between 8 and 25% water;
covering the substrate with the wood veneer having a thickness from about 0.2 to 1.2 mm; and
applying hydrostatic pressure to the film in the presence of heat.

12. The method according to claim 11 wherein covering the substrate with a film is covering the substrate with a wood veneer having a moisture content from about 10 and 15% water.

13. The method according to claim 11 wherein coating the substrate with an adhesive layer is coating the substrate with one of polyurethane or epoxy.

14. The method according to claim 11 further comprising softening the wood veneer.

15. A method for producing interior trim comprising:
providing an interior trim substrate which is formed of a polymer substrate is a polymer material selected from the group consisting of reinforced thermoplastic material, fiber glass reinforced nylon, fiber glass polyethylene, ABS, thermoplastic olefin, and TPE;
coating the substrate with an adhesive layer;
applying a fabric backing to a wood veneer having a moisture content of between 8 and 25% water;
covering the substrate with the wood veneer having a thickness from about 0.2 to 1.2 mm; and
applying hydrostatic pressure to the film in the presence of heat.

16. The method according to claim 15 further comprising curing the adhesive to an about 80% cured state prior to coupling of the wood veneer to the substrate.

17. The method according to claim 15 wherein coating the substrate with an adhesive layer is coating the substrate with one of polyurethane or two component epoxy.

18. The method according to claim 15 further comprising the step of applying a layer of protective coating over the wood laminate.

19. The method according to claim 15 further comprising the step of bleaching the wood laminate.

20. The method according to claim 15 further comprising the step of softening the wood laminate.
